(19) United States
(12) Patent Application Publication
(10) Pub. No.: US 2008/0164691 A1
(43) Pub. Date: Jul. 10, 2008

(54) Open Locking Ring Comprising a Screw Lock

(75) Inventor: Manfred Meinig, Rietheim-Weilheim (DE)

Correspondence Address: AKERMAN SENTERFITT, P.O. BOX 3188, WEST PALM BEACH, FL, 33402-3188, US

(73) Assignee: METU MEINIG AG, Rietheim-Weilheim (DE)

(21) Appl. No.: 11/908,075

(22) PCT Filed: Mar. 7, 2006
(86) PCT No.: PCT/EP06/02081

§ 371 Date: Sep. 7, 2007

(30) Foreign Application Priority Data
Mar. 8, 2005 (DE) 10 2005 011 071.1
Apr. 14, 2005 (DE) 10 2005 017 368.3

(51) Int. Cl. F16L 23/04; F16L 23/08

(52) U.S. Cl. 285/18; 24/279; 285/386

(57) ABSTRACT

The invention relates to an open locking ring (14) comprising a screw lock which is used to connect pipes comprising end flanges or to fix covers to containers or the like. Said screw lock comprises a clamping screw which extends in the peripheral direction and is embodied as a double spindle (1), the ends of said clamping screw being provided with counter rotating threads (2, 3). Said threads (2, 3) engage in threaded plates (6, 10) with a right-handed inner thread (7) or a left-handed inner thread (11), the threaded plates (6, 10) being pivotably mounted in bearing blocks (15) connected to the ends of the clamping ring (14). The ends (13) of the clamping ring (14) are pulled together or pushed away from each other by actuating the double spindle (1). To this end, the double spindle (1) is provided with a central part (4) embodied as a hexagon such that a simple fork spanner (23) can be used to open or close the screw lock. The ends of the double spindle (1) are provided with inner hexagons (5) so that alternatively an Allen key (22) can be used to actuate the double spindle.

The invention relates to an open locking ring of the kind listed in the Preamble to Claim 1.

For connecting pipes comprising end flanges or for fixing covers to containers or barrels, as well as for fixing other round equipment components, locking rings are frequently used, thus avoiding a multitude of screw connections.

Such locking rings have, depending on the pipe flanges, containers or equipment components, cross sections with different cross-section shapes, ensuring that the components are pulled together and sealed against each other.

For actuation, the open locking rings are provided with one or several turnbuckles which connect the free ends of the locking rings with each other, pulling them together during closing and pushing them apart during opening.

A particularly simple lock design comprises a screw extending in the peripheral direction of the locking ring, with said screw being seated in ends of the locking ring that are bent over at a right angle forming tabs, and a nut seated on the screw or on one of the tabs. This lock comprising a screw and a nut can be actuated using a screw driver or a fork spanner.

For fulfilling higher requirements, bolts or rollers are provided on such a lock, with such pins or rollers being pivotably seated in these corresponding matching seating tabs provided at the locking ring ends, and through which the locking screw passes. Such screw locks are known from DE 197 28 655 A1.

For locking rings with long locking paths, locks with bent screws are advantageous, such as they are described in DE 35 37 504 C1, for example. Here, the bent screws run in parallel with the outer diameter of the locking ring. However, such locks are comparatively difficult to actuate, with special tools being required for tightening. In addition, the locking operation is still too long, and, in particular for uses on construction sites, not very practical.

That is the reason why, in particular for locking rings which must be operated frequently, lever locks are provided, in which the locking screw is replaced with a knee lever or a similar lever. Since, however, the lever allows always only the same locking path, such a locking ring is not suitable for use with equipment components with varying circumferences. In order to adjust the locking path, such a locking ring must be adjustable with, e.g., an additional locking screw. Such a design is very expensive due to significantly higher manufacturing costs. Besides, such a lever lock must be secured against opening automatically by providing additional measures.

Another disadvantage is that, in order to maintain the correct tension, an adjustable lever lock must be readjusted in a time-consuming procedure after it has been closed and opened several times.

For the reasons stated, screw locks are preferred for connecting thin-walled sheet metal pipes having integrated or joined flanges. The problems described are particularly severe with said pipes since such locking rings can be up to 3 meters in diameter, and, due to their limited accessibility, installing them on the ceilings of high factory buildings is often very difficult for a technician standing on a lift or ladder platform.

Hence, the invention has the task of creating a locking ring which is particularly suited to such applications; i.e., a locking ring with a larger diameter with long locking paths, and with limited accessibility, which can be closed and opened quickly and safely.

The present invention has solved this task with an open locking ring comprising a screw lock which is adjustable using simple tools, e.g. screw drivers or spanners, and having the characteristics listed in Claim 1.

According to the characteristic essential for the invention, the locking screw is embodied as a double spindle whose ends have counter rotating threads; i.e. a right-handed thread and a left-handed thread, with which threaded plates and threaded rollers are associated which are mounted in the bearing blocks attached to the locking ring ends and are pivotable around an axis which is parallel to the locking ring axis. For actuating this double spindle, the threaded ends have inner polygons, preferably inner hexagons, into which Allen keys or similar tools can be inserted. In addition, according to another characteristics according to Claim 2, the double spindle's center part which is located between the ends is embodied as a polygon, preferably a hexagon.

This embodiment provides the following options and advantages.

The closing or opening speed is doubled by means of a double spindle having a left-handed and a right-handed thread. For actuating this double spindle, tools that are simply made and operated can be used; i.e. fork spanners for the center part and Allen keys for the polygons provided on the ends, or fork spanners for the center part. This allows installing and removing the locking ring easily and fast even in cases of limited accessibility.

The screw lock which is embodied in a very robust and practically indestructible manner can be manufactured cost-effectively.

Additional characteristics of the locking ring according to this invention are listed in Claims 3 through 11.

When installing the locking ring, which is generally provided in the open state, attention must be paid to the correct screwing direction of the double spindle. Thus, for closing the screw lock, the double spindle must be turned counterclockwise on the left-handed end and clockwise on the right-handed end. Otherwise the lock, which is in its open end position upon delivery, will fall apart. This can happen very easily when electrically or pneumatically powered tools are used.

Since the left-handed thread barely differs from the right-handed thread upon visual inspection, it is suggested according to Claim 3 to color the threaded plates or threaded rollers differently. So, for example, the left-handed threaded plate or threaded roller may be marked using a color, preferably red, during surface finishing.

An even safer solution has been suggested according to Claim 4, according to which a stop shall be provided on at least one end of the double spindle; preferably, a threaded ring which is firmly affixed to the double spindle; preferably, by using an adhesive.

Friction forces are reduced by embodying the bearing blocks and the threaded plates seated therein according to Claim 5, which results in easier actuation.

The suggestions according to Claims 6 through 9 facilitate the installation of the threaded plates or, respectively, are advantageous for the transmission of force or, respectively, for securing these threaded plates in position.

According to Claim 10, a screw lock according to this invention is provided having threaded rollers instead of threaded plates.

According to the suggestion of Claim 11, the bearing blocks can be dimensioned thus that the screw ends protruding in the circumferential direction can be covered almost completely even in the completely closed state.

The subject of the invention is explained in detail below using two embodiment examples shown in the drawings.

The Figures show:

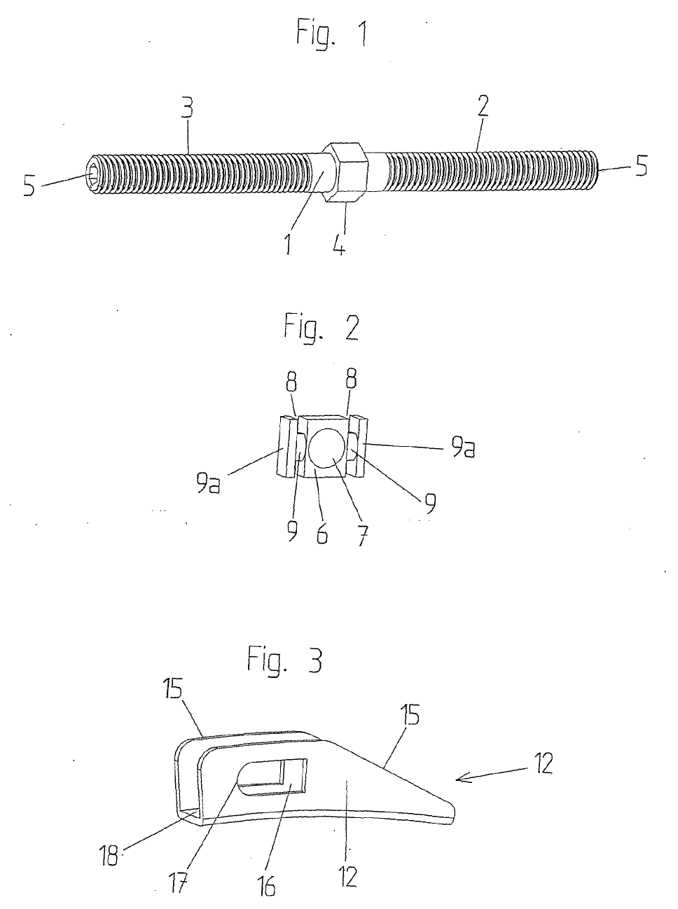

FIG. 1 Perspective view of the double spindle;

FIG. 2 Perspective view of a threaded plate;

FIG. 3 Perspective view of a bearing block;

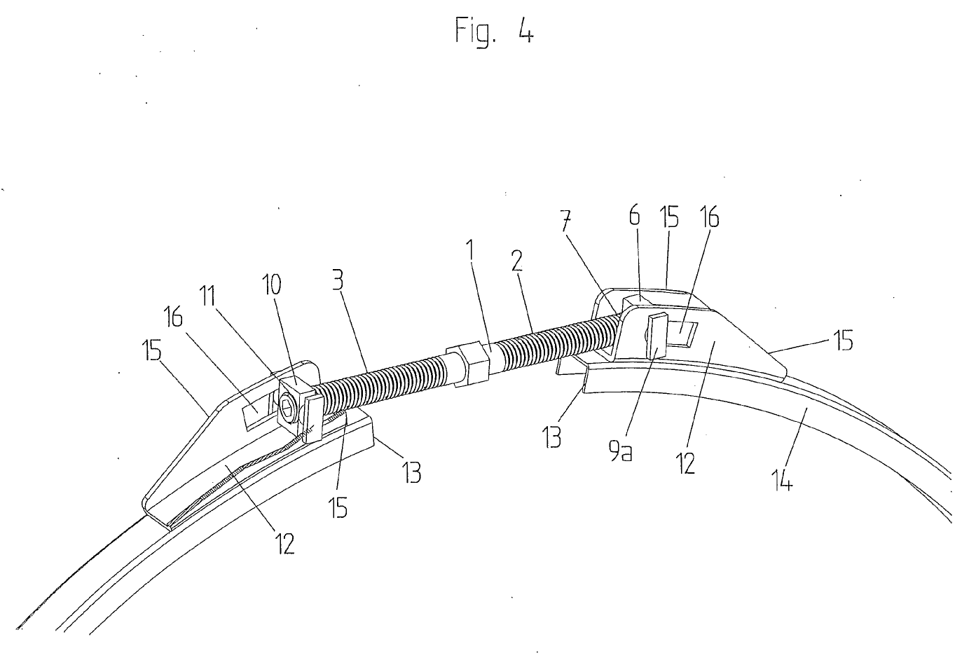

FIG. 4 Perspective and partially exploded view of a screw lock connected to the locking ring, with the locking ring open;

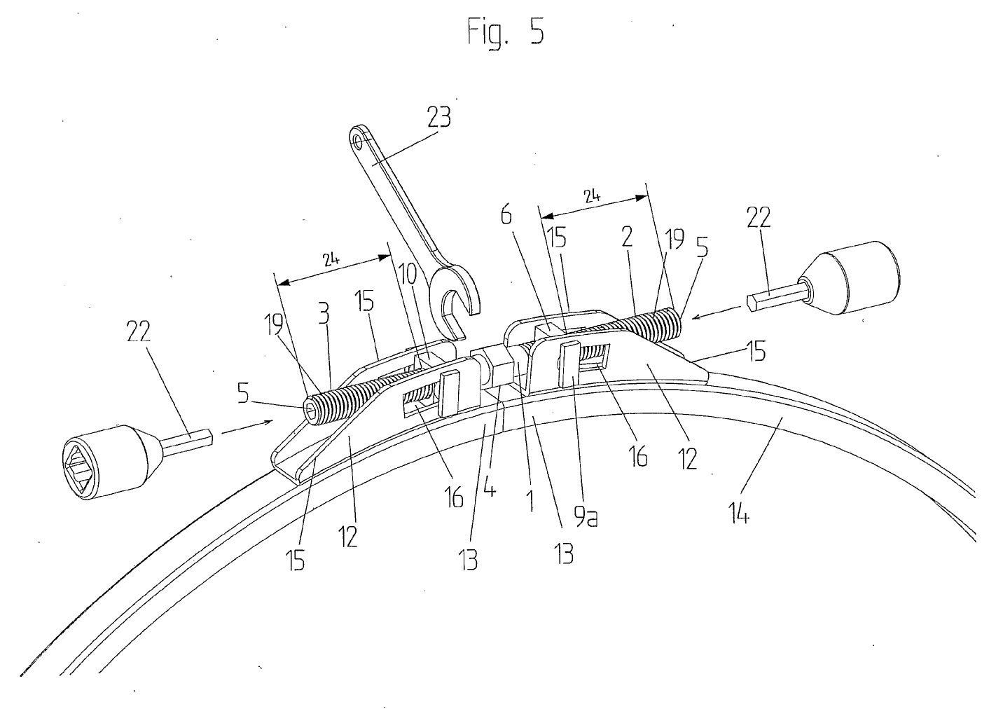

FIG. 5 View according to FIG. 4 with the locking ring closed, and actuating tools indicated;

FIG. 6 Side view of a modified bearing block;

FIG. 7 Section along the line VII-VII in FIG. 6;

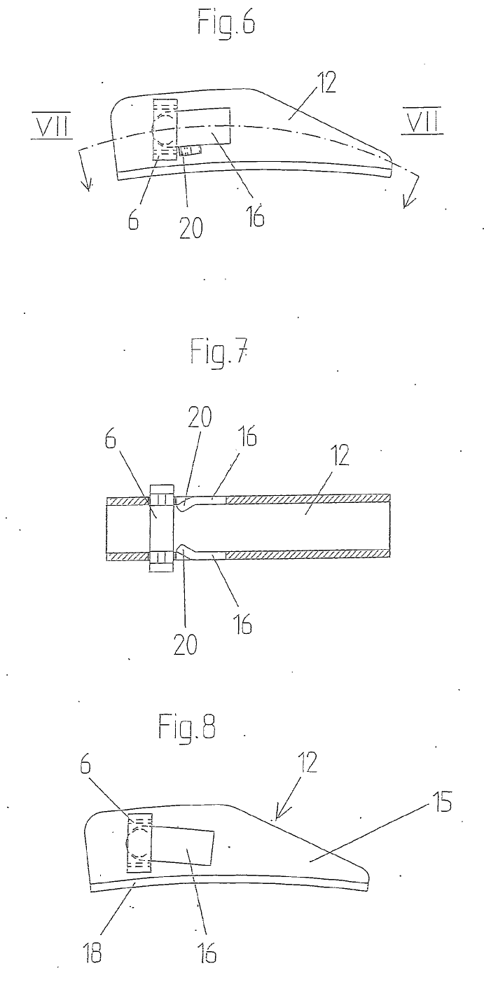

FIG. 8 Side view of a bearing block according to a second modification;

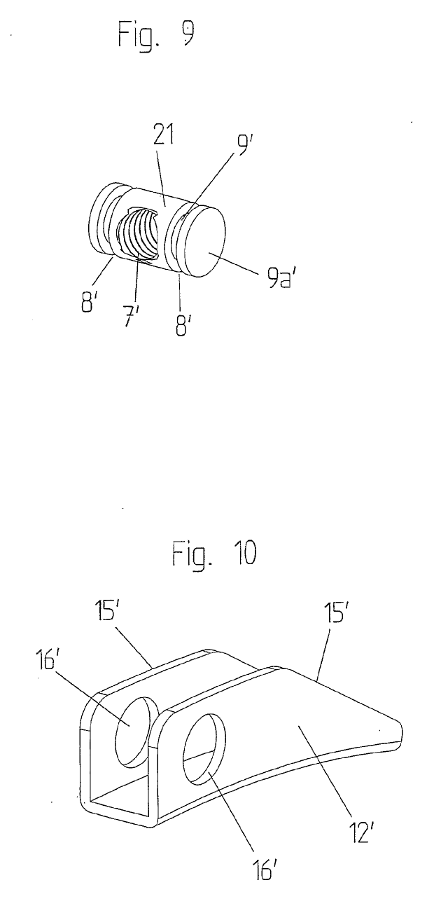

FIG. 9 Perspective view of a threaded roller;

FIG. 10 Perspective view of a bearing block according to its second embodiment for the threaded roller according to FIG. 9;

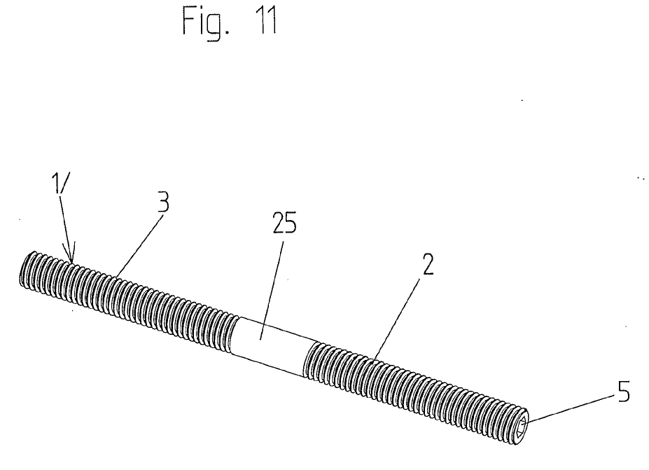

FIG. 11 Perspective view of a double spindle with a center part embodied as a cylinder; and

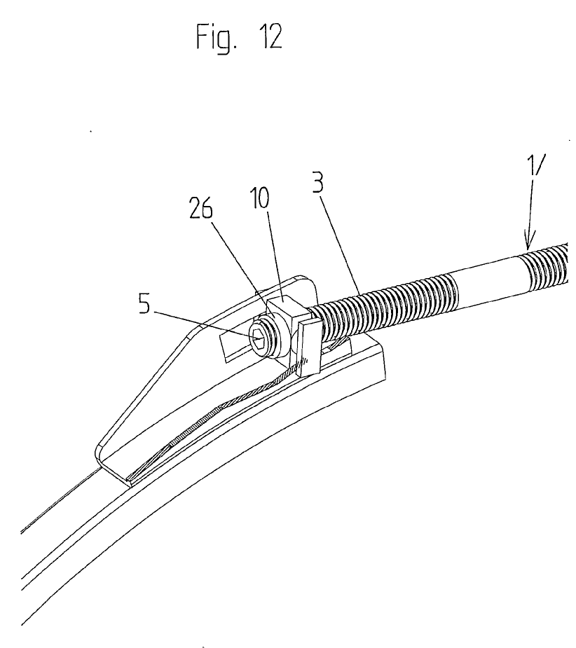

FIG. 12 Perspective view of one half of a screw lock connected to a locking ring according to another embodiment.

Identical parts are marked by identical numbers; modified parts are marked with their prime.

FIGS. 1 through 3 illustrate the essential components for the screw lock according to this invention.

The double spindle 1 essential for the invention, as shown in FIG. 1, has on its right side in FIG. 1 a right-hand thread 2, and on the opposite side, a left-hand thread 3. For actuating this spindle, the center part is embodied as a solid, short hexagon which, as indicated in FIG. 5, can easily be actuated using a spanner embodied as a fork spanner 23.

In addition, inner hexagons 5 have been machined into both spindle ends, into which, as is also indicated in FIG. 5, Allen keys 22 can be inserted.

Threaded plates with matching right-handed or left-handed threads are associated with threaded sections 2 and 3 of double spindle 1. One of these two threaded plates 6 with inner thread 7, here a right-handed inner thread, is shown in FIG. 2. These threaded plates 6 and 10 are equipped on both sides with pivoting axes 9 which have a circular cross-section and are closed off at their ends by cube-shaped end plates 9a, so that grooves 8 are formed between threaded plate 6 and end plates 9. Consequently, threaded plates 6 and 10 are pivotable around an axis running parallel to the locking ring axis.

The threaded plate 10 associated with threaded part 3 of spindle 1, as shown in FIGS. 4 and 5, is embodied identically, but has a left-handed inner thread 11.

These threaded plates 6 or 10, respectively, are seated in bearing blocks 12; of which the right bearing block in FIGS. 4 and 5 is shown as an example in FIG. 3.

The bearing block 12 formed by side walls 15 and the center land 18 connecting said walls has essentially a U-shaped cross-section. The side walls have openings 16 shaped as slotted holes dimensioned such that threaded plates 6 or 10, when rotated by 90°, can be shifted into said openings.

After the threaded plates 6 or 10 have been pivoted into the position shown in FIGS. 4 and 5, the pivoting axes 9 protruding laterally are guided in openings 16, with end plate 9a contacting the outside of side walls 15 so that threaded plates 6 or 10 are laterally secured in their positions.

The areas facing the locking ring ends 13; i.e., the pulling sides of openings 16, are embodied as a semi-circular shape so that pivoting axes 9 of threaded plates 6 or 10 can make positive, and pivotable, contact with said areas.

Side walls 15 must be dimensioned such that they cannot be deformed by the tensile force of double spindle 1, even at maximum load.

Center land 18 that must be connected with locking ring 14, as well as the side walls 15 are rounded in such a fashion that they match the external diameter of the locking ring.

FIG. 4 shows locking ring 14 with the screw lock according to the invention, in its opened state.

The two ends 13 of locking ring 14 are equipped with bearing blocks 12 according to FIG. 3, which are connected to the top of locking rings 14 by a detent system, welding, riveting or a similar method. The threaded plates 6 and 10 are inserted into bearing blocks 12 in the manner described using FIG. 3, with the ends of double spindle 1 having the right-hand and left-hand threads 2,3 the being screwed into the inner threads 7 and 11 of said bearing blocks in such a manner that only few thread flights protrude into the interior space of bearing blocks 12 delimited by side walls 15.

FIG. 5 shows the same design as FIG. 4, but in the closed state of the screw lock. The faces of the ends 13 of locking ring 14 contact each other. The threaded parts 2 and 3 of double spindle 1 are completely screwed into the threaded plates 6 or 10; they are, however, still mostly protected within the interior space of bearing blocks 12 which is delimited by side walls 15. Their protruding ends are marked using double arrow 24, which simultaneously also shows the maximum locking path. If longer locking paths are necessary, correspondingly longer double spindles 1 must be used.

For actuating the screw lock, simple hand tools are used; i.e., alternatively either a fork spanner 23, which must be applied to the center part 4 embodied as a hexagon, or Allen keys 22, which can alternatively be inserted into the inner hexagons 5 on the right or left side of double spindle 1 in FIG. 5.

Thus the screw lock can be actuated even in the most disadvantageous installation situations; namely, from three sides. The Allen keys 22 allow very quick actuation when advantageously inserted in the form of bits into an electrically or pneumatically powered screwdriver.

Fork spanner 23, which must be inserted from the front, can be used in particular when extremely high torques are required; e.g., in the case of rusty locks.

An additional advantage of the screw lock according to this invention is that it allows double the closing and opening speeds, due to the double spindle 1 being equipped with right-handed and left-handed threads 2 and 3. This is essential, in particular, for long closing paths and here, particularly, for manual actuation.

Since the entire closing path is divided into two halves, even in the closed state, screw ends 19 do not protrude as far as is the case for screw locks with single-spindle screws, even in the closed state. Generally, the ends 19 are located protected between side walls 15 of bearing blocks 12, which reduces the safety risk.

The embodiment of bearing blocks 12 explained particularly in FIG. 3 allows a very robust, highly load-resistant design. Since side walls 15 have only relatively small openings 16 for receiving threaded plates 6 and 10, they are considerably more robust than the hooks or eyes used in common screw locks as they are shown; e.g., in DE 197 28 655. This allows dimensioning the bearing blocks 12 smaller, which results in considerable material savings.

When installing a locking ring 14 which is dimensioned so that, in the tension-free state, its outer diameter is slightly larger than the outer diameter of the end flanges to be connected, said locking ring must be opened sufficiently, using the screw lock to counteract the ring's internal stress, so that it can be pushed over the flanges, and then be pulled tight using the screw lock.

In order to allow this, the threaded plates 6 must be prevented from moving back against the direction of pull.

For this purpose, as shown in FIGS. 6 and 7, flaps 20 have been cut out below openings 16, and then pushed in, supporting threaded plate 6 so that it cannot move backwards; i.e. to the right, in FIGS. 6 and 7.

Another option is shown with the modification according to FIG. 8. Herein, the openings provided in side walls 15 are tilted in such a way relative to center land 18 to reduce their distance from center land 18 in reference to the locking direction. This results in threaded plate 6 resting with its bottom side on center land 18 in a position shifted to the right in FIG. 8, which thus prevents said plate from moving backwards.

FIGS. 9 and 10 show another variation of bearing blocks 12′. Instead of the roughly cube-shaped threaded plates 6 or 10, a threaded roller 21 with a right-handed or left-handed inner thread 7′ is provided.

As a seat and bearing for this threaded roller 21, the side walls 15′ of bearing block 12′ are provided with circular openings 16′ with a diameter corresponding to the cross-section of threaded roller 21. Threaded rollers 21 also have pivoting axes 9′ on both ends, which are limited on their ends by end plates 9a′ thus forming an annular groove 8′.

After the threaded roller 21 has been inserted into the circular openings 16′ of the side walls 15′, the edge areas of openings 16′ located next to the locking ring ends engage, under a pulling load, with the grooves 8′ of threaded rollers 21.

Instead of threaded rollers with annular grooves 8′, cylindrical threaded rollers without annular grooves; i.e., smooth rollers, may also be used since with the screw lock closed, the threaded rollers 21 are positively held in the circular openings 16′ by the force.

The most universal screw lock according to the present invention, as it is shown primarily in FIG. 5, has a double spindle with a center part embodied as a hexagon.

If actuation of the screw lock by a fork spanner is not critical, a double spindle 1′, shown in FIG. 11, having a cylindrical center part 25, is also suitable.

Finally, FIG. 12 shows a measure for securing double spindle 1′. This spindle has on its left end a stop ring 26, which is screwed onto the extreme end and affixed to this, preferably by using an adhesive. This ring, which contacts the outside of threaded plate 10 in the end position of the opened screw lock, prevents the double spindle 1′ from being screwed out of the threaded plates completely, thus preventing the screw lock from disintegrating into its parts.

### REFERENCES

1, 1′ Double spindle
2 Right-handed thread (external)
3 Left-handed thread (external)
4 Center part (hexagon)
5 Inner hexagon
6 Threaded plate
7, 7′ Right-handed inner thread
8, 8′ Grooves
9, 9′ Pivoting axis
10 Threaded plate
11 Left-handed inner thread
12, 12′ Bearing blocks
13 End
14 Locking ring
15, 15′ Side walls
16, 16′ Opening
17 Pull side of opening
18 Center land
19 Screw ends
20 Noses
21 Threaded roller
22 Allen key
23 Fork spanner
24 Locking path
25 Cylindrical center part
26 Threaded ring

1. An open locking ring for connecting pipes having end flanges or for fixing covers to containers, whose ends are connected with each other by means of a screw lock, the screw lock comprising:
a locking screw extending in a circumferential direction, passing through radially protruding bearing blocks provided on the locking ring, with at least one of the bearing blocks having a thread holding the locking screw, and the locking screw being adjustable by a spanner, and with the locking ring being elastically flexible for changing its diameter,
wherein the locking screw is embodied as a double spindle (1) whose ends have counter rotational threads (2,3), as well as inner polygons, and threaded plates (6,10) or threaded rollers (21) with counter-rotating threads (7, 11; 7′) are inserted in both bearing blocks (12, 12′), and
wherein said threaded plates (6,10) or threaded rollers (21) are pivotable around an axis running parallel to an axis of the locking ring.

2. The locking ring according to claim 1, wherein the double spindle (1) has a center part (4) which is embodied as a polygon.

3. The locking ring according to claim 1, wherein the threaded plates (6,10) or threaded rollers (21) are different in color indicating thread direction.

4. The locking ring according to claim 1, wherein at least one end of the double spindle (1) is secured by a stop.

5. The locking ring according to claim 1, wherein the bearing blocks (12, 12′) have radially protruding side walls (15, 15′) connected with each other and with the locking ring (14) via a center land (18), and
wherein said bearing blocks (12, 12′) each have openings (16, 16′) in which the threaded plates (6) or threaded rollers (21) are seated pivotably by laterally protruding pivoting axes (9, 9′).

6. The locking ring according to claim 5, wherein openings (16) of side walls (15) are embodied as slotted holes,
wherein a diameter of the pivoting axes (9) corresponds to a height of the openings (16), and
wherein a length of the pivoting axes (9) corresponds to a thickness of the side walls (15), and
wherein at ends of the pivoting axes (9), endplates (9a) are provided whose length is greater than the diameter of the pivoting axes (9), but smaller than the length of the openings (16).

7. The locking ring according to claim 6, wherein a side of the openings (16) facing an end (13) of the locking ring (14) is embodied as a semicircle whose radius corresponds to a radius of the pivoting axes (9).

8. The locking ring according to claim 6, wherein the side walls (15) next to the openings (16) have noses (20) supporting the installed threaded plates (6,10) in the circumferential direction.

9. The locking ring according to claim 6, wherein the openings (16) are slanted with regard to the center land (18) in such a manner that the end plates (9a) contact an upper surface of the center land (18) when shifted against a locking direction, and are thus blocked.

10. The locking ring according to claim 1, wherein the openings (16′), in which threaded rollers (21) with inner threads (7′) are seated pivotably, are circular.

11. The locking ring according to claim 1, wherein a length of side walls (15) is such that an inner space of the bearing block (12) delimited by said side walls (15) almost completely houses the ends of the double spindle (1) even in a contracted state of the locking ring (14).

12. The locking ring according to claim 1, wherein the inner polygons are inner hexagons (5).

13. The locking ring according to claim 2, wherein the center part (4) is embodied as a hexagon.

14. The locking ring according to claim 4, wherein the stop is a threaded ring (26) affixed with adhesive.
